(19) United States
(12) Patent Application Publication
(10) Pub. No.: US 2011/0051666 A1
(43) Pub. Date: Mar. 3, 2011

(54) METHOD OF COMMUNICATION USING SUB-MAP

(76) Inventors: Jeong Ki Kim, Gyeonggi-do (KR); Ki Seon Ryu, Gyeonggi-do (KR); Young Soo Yuk, Gyeonggi-do (KR)

(21) Appl. No.: 12/812,741

(22) PCT Filed: Dec. 30, 2008
(86) PCT No.: PCT/KR2008/007791

§ 371 Date: Jul. 13, 2010

Related U.S. Application Data
(60) Provisional application No. 61/021,310, filed on Jan. 15, 2008.

(30) Foreign Application Priority Data
May 9, 2008 (KR) 10-2008-0043515

(51) Int. Cl. H04W 40/00

(52) U.S. Cl. 370/328

(57) ABSTRACT

A radio access system, and more particularly, a frame structure and a map structure are provided. A communication method includes transmitting an uplink sub-map to a receiver at a first downlink sub-frame included in a predetermined frame, and receiving data via a data burst indicated by the uplink sub-map at a first uplink sub-frame included in the predetermined frame. If the suggested sub-frame structure is used, it is possible to reduce HARQ ACK delay and HARQ retransmission delay.

### TECHNICAL FIELD

The present invention relates to a radio access system, and more particularly, to a frame structure and a map structure. In addition, the present invention relates to a communication method using a frame structure and a map structure.

### Background Art

Hereinafter, a general frame structure used in a radio access system will be described.

FIG. 1 is a view showing a frame structure used in a wideband radio access system (e.g., the IEEE 802.16 system).

Referring to FIG. 1, a horizontal axis of a frame indicates an orthogonal frequency division multiplexing access (OFDMA) symbol as a time unit and a vertical axis of the frame indicates a logical number of a sub-channel as a frequency unit. In FIG. 1, one frame is divided into data sequence channels during a predetermined time period by physical characteristics. That is, one frame includes one downlink (DL) sub-frame and one uplink (UL) sub-frame.

At this time, the DL sub-frame may include one preamble, a frame control header (FCH), a DL-MAP, a UL-MAP, and one or more data bursts. In addition, the UL sub-frame may include one or more UL data bursts and a ranging sub-channel.

In FIG. 1, the preamble is specific sequence data located at a first symbol of each frame and is used to perform synchronization of a mobile station with a base station or estimate a channel. The FCH is used to provide channel allocation information and channel code information related to the DL-MAP. The DL-MAP/UL-MAP is a media access control (MAC) message used for informing a mobile station of channel resource allocation in downlink/uplink. In addition, the data burst indicates the unit of data which is transmitted from a base station to a mobile station or from a mobile station to a base station.

A downlink channel descriptor (DCD) which may be used in FIG. 1 indicates an MAC message indicating the physical characteristics of a DL channel and an uplink channel descriptor (UCD) indicates an MAC message indicating the physical characteristics of a UL channel.

In downlink, referring to FIG. 1, the mobile station detects the preamble transmitted from the base station and performs synchronization with the base station. Thereafter, the DL-MAP may be decoded using information acquired from the FCH. The base station may transmit scheduling information for DL or UL resource allocation to the mobile station in each frame (e.g., 5 ms) using the DL-MAP or UL-MAP.

If the DL-MAP/UL-MAP structure shown in FIG. 1 is used, the base station transmits a map message with a modulation coding scheme (MCS) level which can be received by every mobile station, regardless of a channel status. Accordingly, unnecessary overhead may occur. For example, since mobile stations located in the vicinity of the base station have good channel statuses, a high MCS level (e.g., QPSK 1/2) may be used for encoding or decoding the message. However, the base station encodes the map message with a low MCS level (e.g., QPSK 1/12) and transmits the map message, in consideration of mobile stations which are located at the edges of its cell. Accordingly, since each mobile station always receives the message encoded with the same MCS level, unnecessary map message overhead may occur.

FIG. 2 is a view showing an example of hybrid automatic repeat request (HARQ) control signal delay at the time of transmission of DL data used generally.

Referring to FIG. 2, in any frame (e.g., an N^{th} frame) of a wideband radio access system (e.g., WiMAX), a base station may transmit a DL-MAP to a mobile station and inform the mobile station of DL burst information of a current frame. The mobile station may receive a DL data burst from the base station in an N^{th} frame.

In addition, the base station may transmit a UL-MAP to the mobile station in the N^{th} frame and inform the mobile station of UL channel information for transmitting a control signal (e.g., an acknowledgement (ACK) signal). Accordingly, generally, if the HARQ is applied, the mobile station may transmit an ACK/NACK signal of a DL data burst to the base station in an N+1^{th} frame.

In FIG. 2, HARQ ACK delay may be generated by at least one frame. In addition, if the NACK is generated, retransmission delay may be increased by the processing delay of the base station.

FIG. 3 is a view showing an example of processing delay which may be generated at the time of transmission of an uplink control signal.

Referring to FIG. 3, a base station (BS) may inform a mobile station (MS) of a time and a location for transmitting a control signal in uplink using a UL-MAP message (S301).

At this time, transmission delay and processing delay may be generated due to the physical characteristics of a system and a channel environment. Accordingly, the MS transmits a control signal for DL data to the BS in an N+1^{th} frame due to the transmission delay or the processing delay (S302).

That is, if a general frame structure is used, the control signal may be delayed due to a channel environment or a data processing problem.

### DISCLOSURE OF INVENTION

### Technical Problem

An object of the present invention devised to solve the problem lies on a new map structure and frame structure which may be used in a wideband radio access system.

Another object of the present invention devised to solve the problem lies on an efficient communication method using a new map structure and frame structure. That is, data transmission delay is reduced in a control signal or map message transmission, by providing a communication method suitable for the new map structure and frame structure.

### Technical Solution

The present invention suggested in order to solve the above-described technical problem relates to a communication method using a new frame structure and map structure in a radio access system.

The object of the present invention can be achieved by providing a communication method using a sub-map in a radio access system, the method including: transmitting an uplink sub-map to a receiver at a first downlink sub-frame included in a predetermined frame; and receiving a control signal via a data burst indicated by the uplink sub-map at a first uplink sub-frame included in the predetermined frame.

At this time, the uplink sub-map may include one or more sub-map headers and one or more sub-map bodies. The one or more sub-map bodies may use the same modulation coding scheme (MCS). The one or more sub-map bodies may use different modulation coding schemes (MCSs). In addition, a first sub-map body of the one or more sub-map bodies may include uplink burst allocation information included in the first sub-frame.

At this time, a first sub-map header of the one or more sub-map headers may include a sub-map indicator. At this time, the sub-map indicator may include information indicating whether or not a second sub-map header is present next to the first sub-map header. In addition, the first sub-map header and the second sub-map header may use different modulation coding schemes (MCSs). At this time, the first sub-map header and the second sub-map header may be modulated and coded according to the MCSs of uplink bursts corresponding thereto.

In another aspect of the present invention, provided herein is a communication method using a sub-map in a radio access system, the method including: transmitting a downlink sub-map to a receiver at a sub-frame included in a predetermined frame; and transmitting a downlink signal via a downlink burst indicated by the downlink sub-map at the sub-frame.

The downlink sub-map may include one or more sub-map headers and one or more sub-map bodies. At this time, the one or more sub-map bodies use the same modulation coding scheme (MCS).

In another aspect of the present invention, provided herein is a communication system using a sub-map in a radio access system, the method including: receiving at least one of a downlink sub-map and an uplink sub-map of a first sub-frame included in a predetermined frame from a transmitter; and receiving downlink data via a downlink burst indicated by a first downlink mini sub-map included in the downlink sub-map.

At this time, the method may further include transmitting uplink data via an uplink burst indicated by a first uplink mini sub-map included in the uplink sub-map. At this time, the uplink burst may be a second sub-frame included in the predetermined frame.

### ADVANTAGEOUS EFFECTS

The present invention has the following effects.

First, if the sub-frame structure suggested by the present invention is used, it is possible to reduce HARQ ACK delay and HARQ retransmission delay.

Second, it is possible to reduce downlink control overhead using the sub-map structure suggested by the present invention.

Third, it is possible to improve transmission delay using the sub-frame and the sub-map structure suggested by the present invention and to ensure compatibility with the existing system even in a newly introduced system. That is, it is possible to perform efficient communication using the sub-frame structure and the sub-map structure suggested by the present invention.

### BRIEF DESCRIPTION OF DRAWINGS

The accompanying drawings, which are included to provide a further understanding of the invention, illustrate embodiments of the invention and together with the description serve to explain the principle of the invention.

In the drawings:

FIG. 1 is a view showing a frame structure used in a wideband radio access system (e.g., IEEE 802.16).

FIG. 2 is a view showing an example of hybrid automatic repeat request (HARQ) control signal delay at the time of transmission of downlink (DL) data used generally.

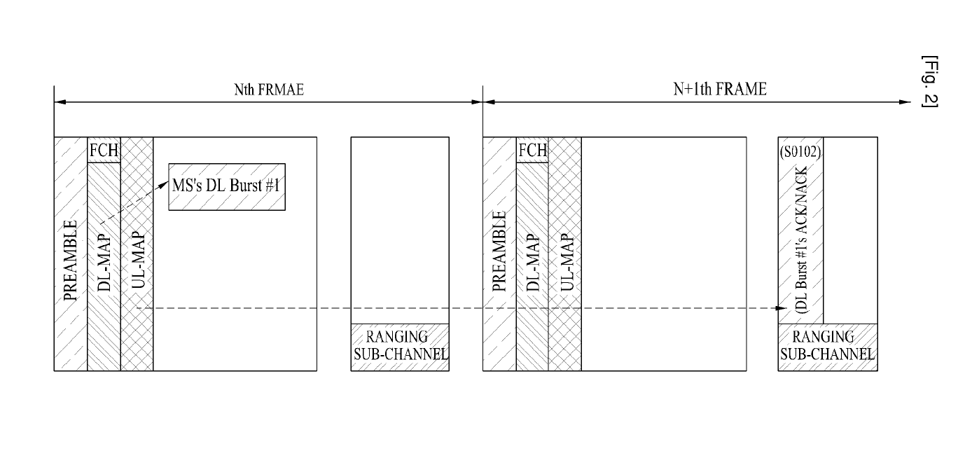

FIG. 3 is a view showing an example of processing delay which may be generated at the time of transmission of an uplink (UL) control signal.

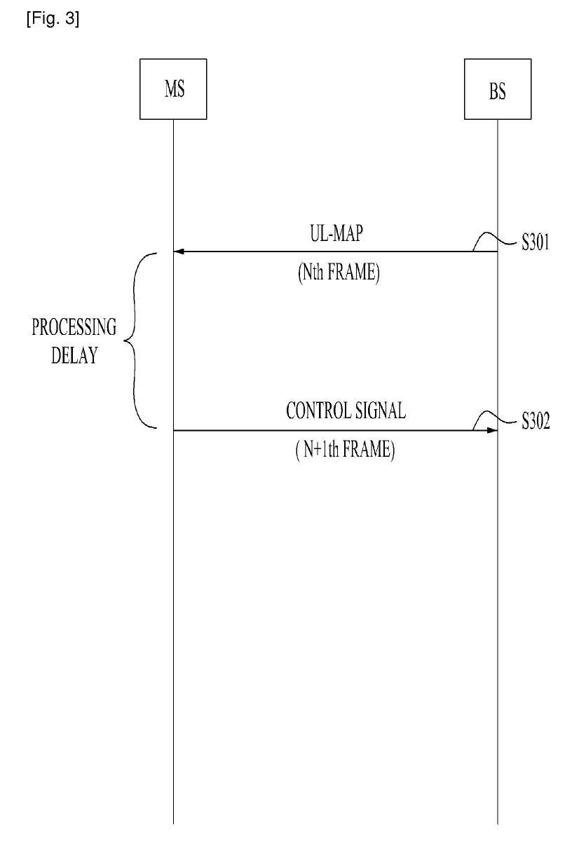

FIG. 4 is a view showing the structure of a compressed DL-MAP, a compressed UL-MAP and a SUB-DL-UL-MAP in a specific frame of a wideband radio access system.

FIG. 5 is a view showing a new frame structure according to an embodiment of the present invention.

FIG. 6 is a view showing an example of a sub-map structure which may be used in an embodiment of the present invention.

FIG. 7 is a view showing a communication method using a sub-frame structure shown in FIG. 5 according to an embodiment of the present invention.

FIG. 8 is a view showing another example of a sub-frame structure according to an embodiment of the present invention.

FIG. 9 is a view showing an example of a method of supporting the existing system using the sub-frame structure defined in the embodiment of the present invention.

FIG. 10 is a view showing another example of a method of supporting the existing system using the sub-frame structure defined in the embodiment of the present invention.

FIG. 11 is a view showing another example of a method of supporting the existing system using the sub-frame structure defined in the embodiment of the present invention.

FIG. 12 is a view showing another example of a method of supporting the existing system using the sub-frame structure defined in the embodiment of the present invention.

### MODE FOR THE INVENTION

In order to solve the problems, the present invention provides a communication method using a new frame structure and map structure in a radio access system.

The following embodiments are proposed by combining constituent components and characteristics of the present invention according to a predetermined format. The individual constituent components or characteristics should be considered to be optional factors on the condition that there is no additional remark. If required, the individual constituent components or characteristics may not be combined with other components or characteristics. Also, some constituent components and/or characteristics may be combined to implement the embodiments of the present invention. The order of operations to be disclosed in the embodiments of the present invention may be changed to another. Some components or characteristics of any embodiment may also be included in other embodiments, or may be replaced with those of the other embodiments as necessary.

The embodiments of the present invention are disclosed on the basis of a data communication relationship between a base station and a mobile station. In this case, the base station is used as a terminal node of a network via which the base station can directly communicate with the mobile station. Specific operations to be conducted by the base station in the present invention may also be conducted by an upper node of the base station as necessary.

In other words, it will be obvious to those skilled in the art that various operations for enabling the base station to communicate with the mobile station in a network composed of several network nodes including the base station will be conducted by the base station or other network nodes other than the base station. The term base station may be replaced with a fixed station, Node-B, eNode-B (eNB), or an access point as necessary. The term mobile station may also be replaced with a user equipment (UE), a mobile station (MS) or a mobile subscriber station (MSS) as necessary.

The following embodiments of the present invention can be implemented by a variety of means, for example, hardware, firmware, software, or a combination of them.

In the case of implementing the present invention by hardware, the present invention can be implemented with application specific integrated circuits (ASICs), Digital signal processors (DSPs), digital signal processing devices (DSPDs), programmable logic devices (PLDs), field programmable gate arrays (FPGAs), a processor, a controller, a microcontroller, a microprocessor, etc.

If operations or functions of the present invention are implemented by firmware or software, the present invention can be implemented in the form of a variety of formats, for example, modules, procedures, functions, etc. The software codes may be stored in a memory unit so that it can be driven by a processor. The memory unit is located inside or outside of the processor, so that it can communicate with the aforementioned processor via a variety of well-known parts.

The specific terms used in the following description are provided for facilitating the understanding of the present invention and may be changed without departing from the technical spirit of the present invention.

For example, a frame may include at least one downlink sub-frame and at least one uplink sub-frame. At this time, at least one downlink sub-frame may be called a downlink mini frame. In addition, at least one uplink sub-frame may be called an uplink mini frame.

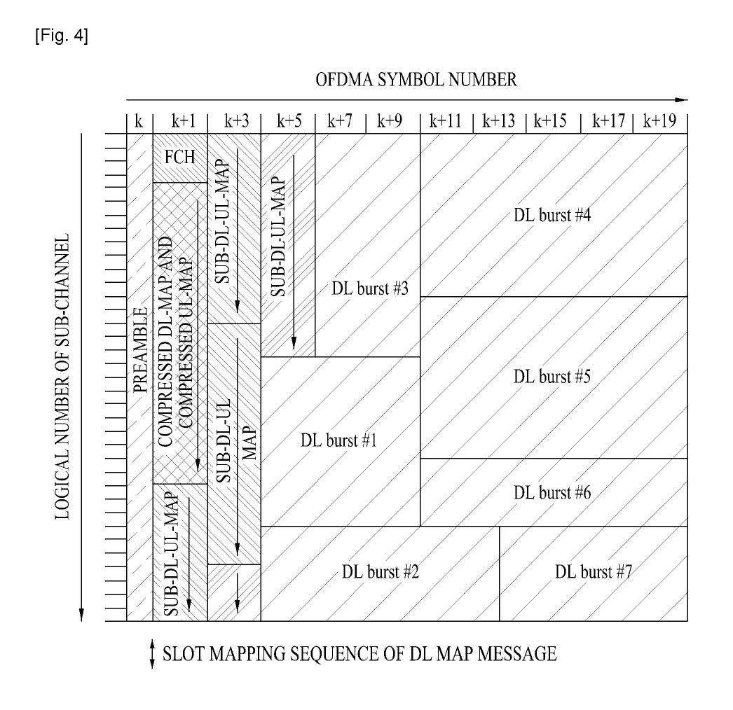

FIG. 4 is a view showing the structure of a compressed DL-MAP, a compressed UL-MAP and a SUB-DL-UL-MAP in a specific frame of a wideband radio access system.

FIG. 4 shows the frame structure using the compressed DL-MAP, the compressed UL-MAP and the SUB-DL-UL-MAP in order to reduce overhead of a DL-MAP or UL-MAP message used generally.

Table 1 shows an example of the format of the compressed DL-MAP message.

TABLE 1

| Syntax | Size | | Contents |
|---|---|---|---|
| Compressed_DL-MAP( ) { | | | |
| Compressed map indicator | 3 | bits | Indicates a compressed |
| | | | map format when |
| | | | this is set to 110. |
| UL-MAP appended | 1 | bit | |
| Reserved | 1 | bit | Set to 0. |
| Map message length | 11 | bits | |
| PHY Synchronization Field | 32 | bits | |
| DCD Count | 8 | bits | |
| Operator ID | 8 | bits | |
| Sector ID | 8 | bits | |
| No. OFDMA symbols | 8 | bits | Number of OFDMA |
| | | | symbols in a DL |
| | | | sub-frame including all |
| | | | AAS/conversion areas. |
| DL IE count | 8 | bits | |
| for (i = 1; i <= DL IE count; i++) { | | | |
| DL-MAP_IE( ) | Variable | | |
| } | | | |
| if !(byte boundary) { | | | |
| Padding Nibble | 4 | bits | Padding bits |
| } | | | |
| } | | | |

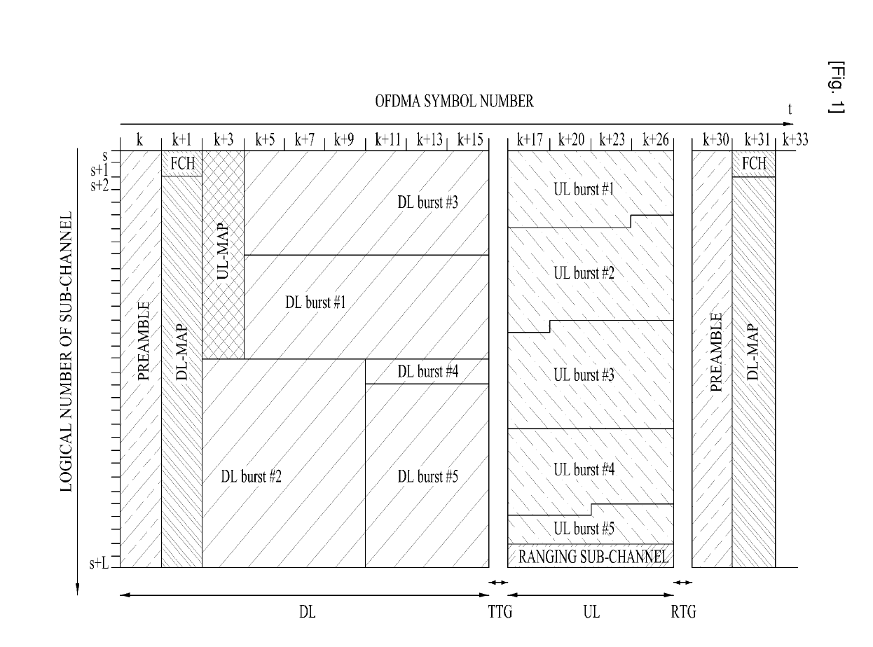

The compressed DL-MAP is obtained by compressing unnecessary information which is present in the DL-MAP shown in FIG. 1. If the compressed DL-MAP format is used, the whole 48-bit base station (BS) identifier (ID) is indicated only within the DCD.

In Table 1, a compressed MAP indicator has 3 bits and indicates whether or not a compressed MAP message is used. A UL-MAP appended parameter indicates that the compressed UL-MAP is appended to a current compressed DL-MAP data structure. A MAP message length parameter indicates the length of the compressed DL-MAP and starts at a byte including the compressed MAP indicator. A PHY synchronization field includes frame number and frame period information. A DCD count parameter indicates a DL burst profile applied to a current map. A DL-IE count field indicates an IE input number in a next DL_MAP_IE list. When the UL-MAP is not appended to the DL-MAP, the UL-MAP message is always transmitted in a burst indicated in a first DL-MAP_IE of the DL-MAP.

Table 2 shows an example of the format of the compressed UL-MAP message.

TABLE 2

| Syntax | Size | Contents |
|---|---|---|
| Compressed_UL-MAP( ) { | | |
| UCD Count | 8 bits | |
| Allocation Start Time | 32 bits | |
| No. OFDMA symbols | 8 bits | Number of OFDMA symbols in |
| | | a DL sub-frame including all |
| | | AAS/conversion areas |
| while (map data remains){ | | |
| UL-MAP_IE( ) | Variable | |
| } | | |
| if !(byte boundary) { | | |
| Padding Nibble | 4 bits | Padding bits |
| } | | |
| } | | |

The compressed UL-MAP is appended to the back of the compressed DL-MAP and may not be selectively included. In Table 2, a UCD count field indicates a UL burst profile applied to a current map, and is equal to a coefficient value of a configuration change of the UCD. An allocation start time field indicates a UL allocation start time defined in the UL-MAP.

Table 3 shows an example of the format of the SUB-DL-UP-MAP message.

TABLE 3

| Syntax | Size | Contents |
|---|---|---|
| SUB-DL-UL-MAP( ) { | — | — |
| Compressed map indicator | 3 bits | Set to 0b111. |
| Map message length | 10 bits | — |
| RCID_Type | 2 bits | 0b00 = Normal CID0b01 = |
| | | RCID110b10 = |
| | | RCID70b11 = RCID3 |
| HARQ ACK offset indicator | 1 bit | — |
| If (HARQ ACK offset indicator | — | — |
| == 1){ | | |
| DL HARQ ACK offset | 8 bits | — |
| UL HARQ ACK offset | 8 bits | — |
| } | — | — |
| DL IE Count | 8 bits | — |
| For (i=1; i <= DL IE Count; | — | — |
| i++){ | | |
| DL-MAP_IE( ) | Variable | — |
| } | — | — |
| OFDMA Symbol offset | 8 bits | This value indicates start |
| | | symbol offset of subsequent |
| | | sub-bursts in this UL |
| | | allocation start IE. |
| Sub-channel offset | 7 bits | This value indicates start |
| | | sub-channel offset of |
| | | subsequent sub-bursts in |
| | | this UL allocation start IE. |
| Reserved | 1 bit | Set to 0. |
| while (map data remains){ | — | — |
| UL-MAP_IE( ) | Variable | — |
| } | — | — |
| If !(byte boundary) { | | |
| Padding Nibble | Variable | Padding bits |
| } | — | — |
| } | — | — |

The SUB-DL-UL-MAP message does not include an MAC header, but includes a DL-MAP IE and a UL-MAP IE. In Table 3, a compressed map indicator is set to “0b111” and indicates the type of the SUB-DL-UL-MAP. A MAP message length field has 11 bits and indicates the length of the SUB-DL-UL-MAP message. An RCID_Type field has two bits and indicates the type of the RCID used in the SUB-DL-UL-MAP.

In Table 3, a DL HARQ ACK offset and a UL HARQ ACK offset have 8 bits and indicate offset values for the HARQ ACK in downlink and uplink, respectively. In addition, an OFDMA symbol offset field indicates a start symbol offset of subsequent sub-bursts in the UL allocation start IE. In addition, a sub-channel offset field indicates an offset value of a start sub-channel offset of subsequent sub-bursts.

Table 4 shows an example of the format of a HARQ and Sub-MAP pointer IE.

TABLE 4

| Syntax | Size | | Contents |
|---|---|---|---|
| HARQ and Sub- | — | | — |
| MAP_Pointer_IE( ) { | | | |
| Extended DIUC | 4 | bits | HARQ_P = 0x07 |
| Length | 4 | bits | Length = 0x02 |
| While (data remains) { | — | | — |
| DIUC | 4 | bits | Indicates the AMC level of the burst containing |
| | | | an HARQ MAP message. |
| No. Slots | 8 | bits | The number of slots allocated for the burst |
| | | | containing an HARQ MAP message. |
| Reserved | 4 | bits | Set to 0. |
| Repetition Coding | 2 | bits | 0b00 - No repetition coding 0b01 - Repetition |
| Indication | | | coding of 2 used 0b10 - Repetition coding of 4 |
| | | | used 0b10 - Repetition coding of 6 used |
| MAP Version | 2 | bits | 0b00 - HARQ MAPv1 0b01 - Sub-MAP 0b10 - |
| | | | Sub-MAP with CID Mask included 0b11 - |
| | | | Reserved |
| If (MAP Version == | — | | — |
| 0b10) { | | | |
| Idle users | 1 | bit | Bursts for Idle users included in the Sub-MAP. |
| Sleep users | 1 | bit | Bursts for Sleep users included in the Sub-MAP |
| CID Mask Length | 2 | bits | 0b00: 12 bits 0b01: 20 bits 0b10: 36 bits 0b11: 52 bits |
| CID mask | n | bits | The number of bits of CID Mask is determined |
| | | | by CID Mask Length. When the MAP message |
| | | | pointed by this pointer IE includes any MAP IE |
| | | | for an awake mode MS, the bit index corresponding |
| | | | to ((Basic CID of the MS) MOD n) in this CID mask field |
| | | | shall be set to 1. Other-wise, it may be set to 0. |
| } | — | | — |
| Reserved | 0 or 4 | bits | For a byte alignment of IE. Shall be set to zero. |

| | | |
|---|---|---|
| } | — | — |

In Table 4, the HARQ and Sub-MAP pointer IE indicates information about the HARQ message or the SUB-DL-UL-MAP message (an AMC level, a length, coding information or the like). That is, the HARQ and Sub-MAP pointer IE indicates the SUB-DL-UL-MAP or the HARQ MAP message. The HARQ and Sub-MAP pointer IE may be included in the compressed DL-MAP message.

If the compressed DL-MAP and the compressed UL-MAP shown in FIG. 4 are used, overhead of the general DL-MAP and UL-MAP shown in FIG. 1 can be reduced. That is, the compressed DL-MAP/UL-MAP structure and the SUB-DL-UL-MAP structure may be used in consideration of the channel statuses of the mobile stations.

For example, if the SUB-DL-UL-MAP is configured based on the MCS group of mobile stations, message overhead can be further reduced compared with the case where the DL/UL-MAP message shown in FIG. 1 is used. If the SUB-DL-UL-MAP allocated to a first group is encoded and transmitted by QPSK 1/12, the SUB-DL-UL-MAP allocated to a second group is encoded and transmitted by QPSK 1/4, and the SUB-DL-UP-MAP allocated to a third group is encoded and transmitted by 16QAM 1/2 based on the MCS group of mobile stations, all the mobile stations can process the DL-MAP by a smaller number of resources with respect to all bursts, compared with the case where the SUB-DL-UL-MAP is transmitted by the same QPSK 1/12.

If the compressed map and the SUB-DL-UL-MAP structure are used, a DL resource may be wasted due to unnecessary repeated information. Accordingly, in the embodiments of the present invention, a new frame different from the existing frame structure (e.g., FIG. 1) and a new map structure are suggested. Hereinafter, the new frame structure and map structure will be described.

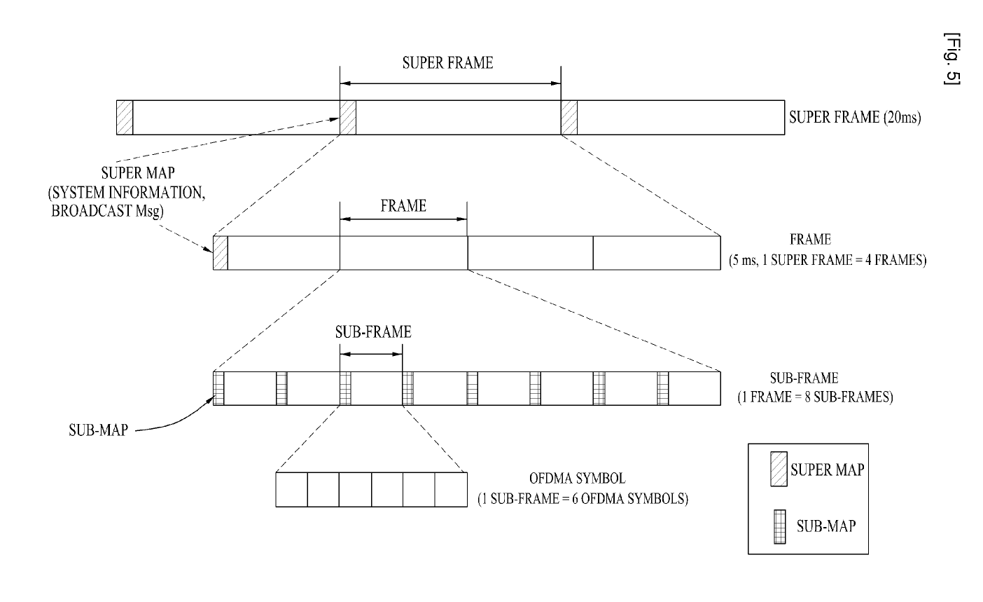

FIG. 5 is a view showing a new frame structure according to an embodiment of the present invention.

Referring to FIG. 5, one super frame includes one or more frames, and one frame includes one or more sub-frames. In addition, one sub-frame may include one or more OFDMA symbols.

The lengths and the numbers of super frames, sub-frames and symbols may be adjusted by the requirement of a user or a system environment. In the embodiments of the present invention, the term sub-frame is used. At this time, the sub-frame indicates a whole lower frame structure generated by dividing one frame by a predetermined length.

The sub-frame structure used in the embodiments of the present invention may be configured by dividing the frame used generally into one or more sub-frames. At this time, the number of sub-frames included in one frame may be decided by the number of symbols configuring the sub-frame. For example, it is assumed that one frame is composed of 48 symbols. If one sub-frame is composed of six symbols, one frame may be composed of eight sub-frames. In addition, if one sub-frame is composed of 12 symbols, one frame may be composed of four sub-frames.

In FIG. 5, it is assumed that the length of one super frame is 20 ms and the length of the frame is 5 ms. That is, one super frame may be composed of four frames. In addition, one frame has a frame structure composed of eight sub-frames. At this time, one sub-frame may be composed of six OFDMA symbols.

In FIG. 5, a super frame map is present in the front side of each super frame. The super frame map may be called a super map. In addition, a sub-frame map is present in the front side of the sub-frame. The sub-frame map may be called a sub-map.

Table 5 shows an example of information which may be included in the sub-map in exemplary embodiments of the present invention.

TABLE 5

| Syntax | Value |
|---|---|
| Sub-map (Scheduling Information) | |
| [Channel Type Info] - DL/UL - MIMO/ | |
| SIMO/Collaborated MIMO - Scheduling/ | |
| Power Control only - Etc[CID or | |
| Scheduling ID][Resource Allocation] | |
| [Transmit Format Info] - Transmit MCS | |
| level - MIMO information[HARQ info] - | |
| HARQ process ID - New/Re-indicator - CC | |
| or IR/RV info[UL Power Control Info][CQI | |
| Channel Info][ACK/NACK for UL Burst] | |
| Etc. | |

Table 5 shows scheduling information included in the sub-map used in the embodiments of the present invention.

Referring to Table 5, the sub-map may include information related to a burst transmission in a sub-frame, such as channel type information indicating whether a current channel is a DL channel, a UL channel, a multi input multi output (MIMO) or a single input multi output (SIMO), CID or scheduling ID information indicating to which connection a resource is allocated, resource allocation information indicating the location and the size of an allocated resource, transmit format information indicating MIMO information or an MCS level, HARQ information when the HARQ is used (a HARQ process ID, a new/Re-transmission indicator, CC or IR information, etc.), UL power control information, CQI channel information, and ACK/NACK information for a UL burst.

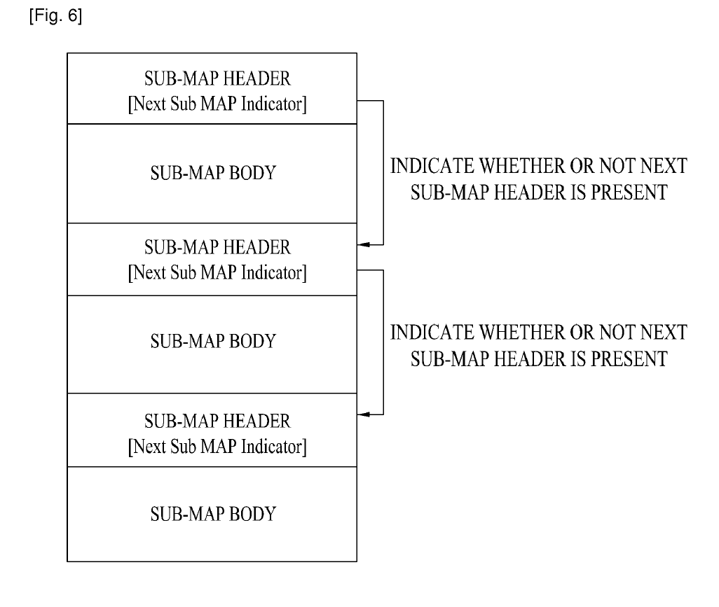

FIG. 6 is a view showing an example of a sub-map structure which may be used in an embodiment of the present invention.

The sub-map structure may comprise a sub-map header and a sub-map body. The sub-map header may include information about the sub-map body (e.g., the length of the sub-map body, the AMC level of the sub-map body, and so on). In addition, the sub-map body may include scheduling information.

In the embodiments of the present invention, one sub-frame may include one or more sub-map structures. In FIG. 6, a pair of a sub header and a sub body included in the sub-map included in one sub-frame may be called a mini sub-map. At this time, the sub-map header (or the mini sub-map header) may include a next sub-map indicator indicating whether or not another sub-map is present in the same sub-frame.

Referring to FIG. 6, the sub-map structure may include one or more sub-map headers and one or more sub-map bodies in each sub-frame. If one or more sub-maps are included in one sub-frame, it is determined whether or not a next sub-map is present, by the next sub-map indicator of the current sub-map header.

That is, if the next sub-map indicator of the sub-map header is set to “1”, it is indicated that another sub-map follows. For example, if it is assumed that one sub-frame is composed of three sub-maps as shown in FIG. 6, the next sub-map indicators of the first sub-map header and the second sub-map header are set to “1” and the next sub-map indicator of the third sub-map header is set to “0”.

Each of the sub-map headers may have a fixed size and the sub-map body may be located next to each of the sub-map headers. The sub-map header has a highest MCS level (robust against a channel error) (e.g., QPSK 1/12), but may have another MCS level according to the channel status of the mobile station.

For example, in FIG. 6, a first sub-map header is located at a first symbol and a first sub-channel of a sub-frame. In addition, the first sub-map header has a highest MCS level (robust against a channel error) (e.g., 1/12). The first sub-map header may include a next sub-map indicator indicating first sub-map body information and whether or not another sub-map is present.

The sub-map body may include allocation information of data bursts allocated to the sub-frame and a variety of channel information related to the sub-frame. The number of sub-maps may be divided based on the MCS. For example, the sub-map structure including information about a total of four DL bursts (e.g., two downlink bursts with QPSK 1/2, one downlink burst with 16QAM 3/4, and one downlink burst with 64QAM 3/4) may be composed of a total of three sub-map structures based on the MCS.

If the configuration of the sub-map header may vary according to the MCS in FIG. 6, the sub-map structure may be configured in descending order of MCS level (that is, from the MCS level robust against a channel error). For example, in FIG. 6, the sub-map header and the sub-map body for QPSK 1/2 are located at the foremost side of the sub-frame, and the sub-map header may indicate the sub-map structure for 16QAM 3/4. In addition, the sub-map header corresponding to the 16QAM 3/4 may indicate the sub-map structure of 64QAM 3/4.

Table 6 shows an example of the format of the sub-map header which may be used in the embodiments of the present invention.

TABLE 6

| Syntax | Size | Contents |
|---|---|---|
| Sub MAP Header format( ) { | — | — |
| Sub-MAP Body length | 8 bits | |
| Repetition_Coding_Indication | 2 bits | 0b00: No repetition coding0b01: |
| | | Repetition coding of 20b10: |
| | | Repetition coding of 40b11: |
| | | Repetition coding of 6 |
| Next Sub MAP Indicator | 1 bits | — |
| } | — | — |

Table 6 shows an example of header information which may be included in the sub-map header. Referring to Table 6, the sub-map header may include a sub-map body length field indicating the length of the sub-map body and a repetition coding indication field indicating the coding degree of the sub-map body. In addition, the sub-map header may include a next sub-map indicator indicating whether or not another sub-map is present. The MCS (or AMC) level of the sub-map header may use QPSK 1/2 robust against the channel error.

Table 7 shows another example of the sub-map header format which may be used in the embodiments of the present invention.

TABLE 7

| Syntax | Size | Contents |
|---|---|---|
| Sub MAP Header format( ) { | — | — |
| Sub-MAP Body Index | TBD | Varies according to the map type |
| | | and the MCS level. |
| Next Sub-MAP Header Indicator | TBD | Varies according to the MCS. |
| } | — | — |

Referring to Table 7, the sub-map header format may include a sub-map body index and a next sub-map header indication field. At this time, if the sub-map has a restricted type and a restricted MCS level, the sub-map body index field may be configured by a combination of the type information and the MCS level information of the sub-map. The sub-map body index field may be represented by giving a series of numbers to all possible combinations according to the MCS level and the sub-map type.

In Table 7, the next sub-map header indicator field may perform two roles. For example, if the next sub-map header indicator field uses one bit, it is indicated whether or not the next sub-map is present using “0” (the next sub-map is not present) and “1” (the next sub-map is present). If the next sub-map header indicator field uses two or more bits, the encoding scheme of the next sub-map may be represented by 0 (none), 1 (MCS 1), 2 (MCS 2), . . . and N (MCS N).

Table 8 shows an example of combinations of the sub-map body index field included in Table 7.

TABLE 8

| | Sub-map | Sub-map | Sub-map | Sub-map |
|---|---|---|---|---|
| | type 1 | type 2 | type 3 | type 4 |
| MCS 1 | 0000 | 0001 | 0010 | 0011 |
| MCS 2 | 0100 | 0101 | 0110 | 0111 |
| MCS 3 | 1000 | 1001 | 1010 | 1011 |

Referring to Table 8, if it is assumed that the length and the contents of the sub-map are fixed according to the sub-map type in Table 7, the sub-map body index field may be configured using only the MCS level information. That is, all cases may be represented by a smaller number of bits than that of Table 7 (the case of representing both the sub-map type and the MCS level).

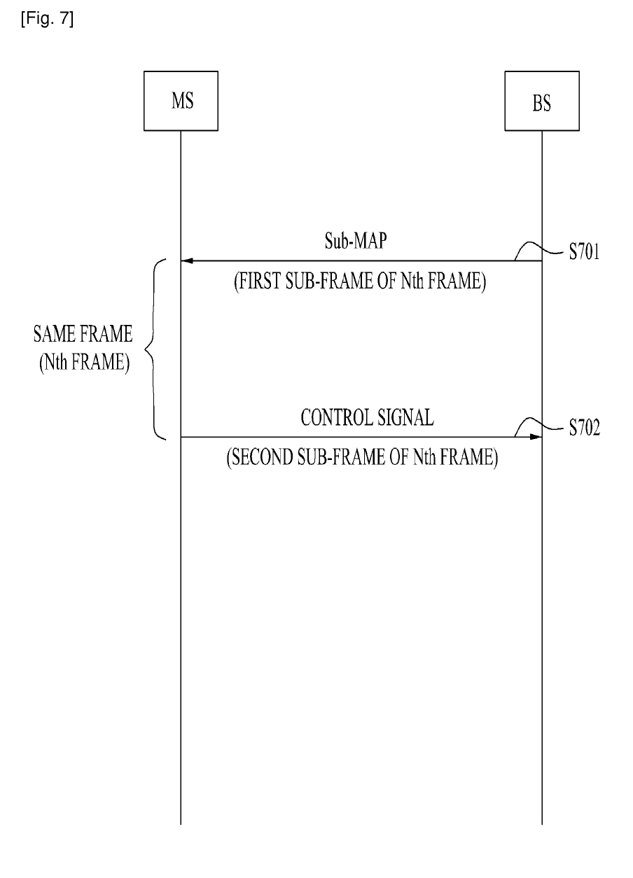

FIG. 7 is a view showing a communication method using the sub-frame structure shown in FIG. 5 according to an embodiment of the present invention.

Referring to FIG. 7, a base station (BS) transmits a sub-map to a mobile station (MS) in a first sub-frame of an N^{th} frame in order to allocate a radio resource (S701).

In the step S701, the sub-map transmitted to the MS may include DL and UL resource information. At this time, as the sub-map used in the step S701, the sub-map shown in FIG. 6 may be referred to.

The MS which receives the sub-map may check frame allocation information included in the sub-map. Accordingly, the MS may receive DL data bursts via the allocated DL channel. In addition, the MS may transmit a control signal using a UL control channel allocated by the BS in a second sub-frame of the N^{th} frame (S702).

That is, if the data communication method shown in FIG. 7 is used, the control signal is transmitted within the same frame (N^{th} frame), thereby reducing the transmission delay of the control signal.

Hereinafter, the sub-frame structure and the sub-map structure applicable to FIG. 7 will be described.

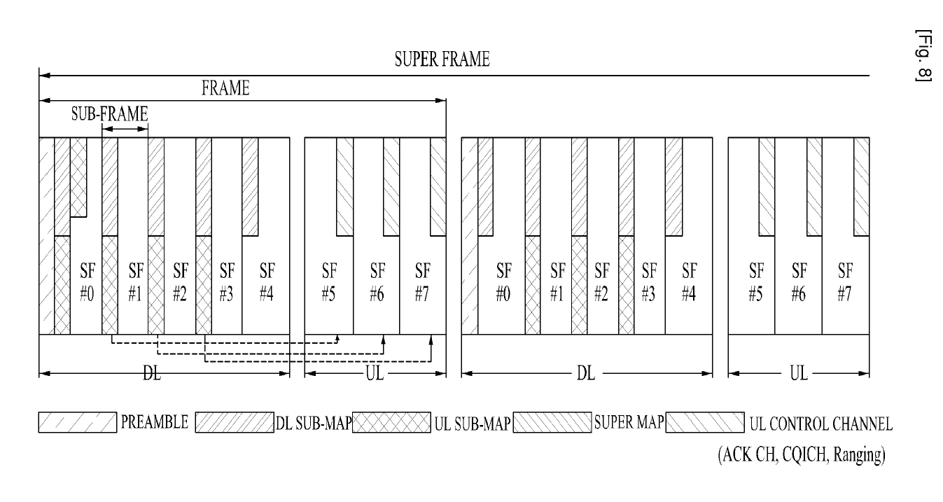

FIG. 8 is a view showing another example of a sub-frame structure according to an embodiment of the present invention.

In FIG. 8, a super frame may include one or more frames, and one frame may include one or more DL sub-maps and one or more UL sub-maps. At this time, the super frame structure may include a preamble, a DL-sub-map, a UL-sub-map, a super map, and a UL control channel. At this time, the super map may be located next to the DL-sub-map.

FIG. 8 shows an example of a frame structure in which one frame is recomposed by eight sub-frames. The number of sub-frames configuring a frame (5 ms) may be determined by the number of symbols configuring one sub-frame. When one frame is composed of a total of 48 (or 49 in the TDD) symbols, one sub-frame (SF) may be composed of 6 OFDMA symbols.

The DL-sub-map may include DL scheduling information of a current sub-frame and a super map indicator. The DL-sub-map may be located at the foremost side of each sub-frame. At this time, the UL-sub-map includes UL scheduling information and may be located next to the DL-sub-map. The allocation information of the UL-sub-map may be indicated by the downlink sub-map.

The super map may be located at a first sub-frame in the super frame. Only when the super map indicator included in the sub-frame indicates the presence of the super map, the super map is located at the first sub-frame of the frame. The super map indicator may be located at the sub-map, the preamble or the FCH (if the FCH is present).

In FIG. 8, a UL control channel (e.g., a HARQ ACK/NACK channel, a high-speed feedback channel (CQICH), a ranging channel or the like) may be included in each of the UL sub-frames SF #5, SF #6 and SF #7. The UL-sub-map indicating the radio resource which will be allocated to the UL sub-frames SF #5, SF #6 and SF #7 may be included in DL sub-frames SF #1, SF #2 and SF #3 in consideration of the processing delay time of the MS. Accordingly, in FIG. 8, the UL-sub-maps corresponding to the UL sub-frames SF #5, SF #6 and SF #7 are present at the DL sub-frames SF #1, SF #2 and SF #3, respectively.

Table 9 shows an example of a DL_frame_prefix_format which is corrected in order to apply the embodiment of the present invention.

TABLE 9

| Syntax | Size | Contents |
|---|---|---|
| DL_Frame_Prefix_format( ) | — | — |
| { | | |
| Used subchannel bitmap | 6 bits | Bit #0: Subchannel group 0 Bit #1: |
| | | Subchannel group 1 Bit #2: Subchannel group |
| | | 2 Bit #3: Subchannel group 3 Bit #4: |
| | | Subchannel group 4 Bit #5: Subchannel group 5 |
| SuperMAP Indicator | 1 bit | Indicates whether or not the super map is |
| | | present 0b0: The super map is not present. |
| | | 0b1: The super map is present at a current |
| | | frame. |
| Repetition_Coding_Indication | 2 bits | 0b00: No repetition coding on DL-MAP0b01: |
| | | Repetition coding of 2 used on DL-MAP |
| | | 0b10: Repetition coding of 4 used on DL- |
| | | MAP 0b11: Repetition coding of 6 used on |
| | | DL-MAP |
| Coding_Indication | 3 bits | 0b000: CC encoding used on DL-MAP |
| | | 0b001: BTC encoding used on DL-MAP |
| | | 0b010: CTC encoding used on DL-MAP |
| | | 0b011: ZT CC encoding used on DL-MAP |
| | | 0b100: CC encoding with optional interleaver |
| | | 0b101: LDPC encoding used on DL-MAP |
| | | 0b110 to 0b111-Reserved |
| DL-MAP_Length | 8 bits | — |
| Reserved | 4 bits | Shall be set to zero. |
| } | — | — |

Referring to Table 9, the modified DL_frame_prefix_format may include information for the DL-MAP as information included in the FCH. In the embodiments of the present invention, one of reserved bits included in the existing DL frame prefix is defined as the super map indicator, in order to indicate whether or not the super map is present in the current frame.

That is, when the MS receives the FCH, the MS can check whether or not the super map is present in the current frame, by reading the super map indicator. If the super map indicator is set to “b0” it is indicated that the super map is not present in the current frame, and, if the super map indicator is set to “b1” it is indicated that the super map is present in the current frame.

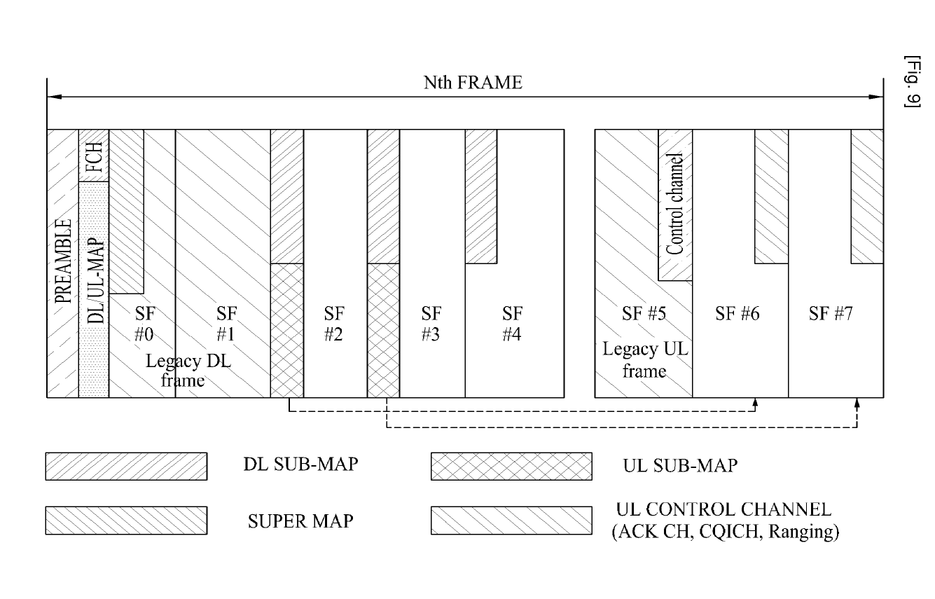

FIG. 9 is a view showing an example of a method of supporting the existing system using the sub-frame structure defined in the embodiment of the present invention.

The sub-frame structure of FIG. 9 is basically similar to FIG. 8. FIG. 9 is different from FIG. 8 in that a legacy frame for supporting a legacy system is included. At this time, the legacy system includes all existing communication systems. In the embodiment of the present invention, it is assumed that the IEEE 802.16e system is used as the legacy system.

Referring to FIG. 9, sub-frames SF #0 and SF #1 are used in a DL sub-frame (legacy DL frame) for supporting the legacy mode and a sub-frame SF #5 is used in a UL sub-frame.

That is, DL sub-frames SF #0 and SF #1 of the legacy system (e.g., IEEE 802.16e) is located in front of DL sub-frames SF #2, SF #3 and SF #4 defined in the present invention, and a UL sub-frame SF #5 is located in front of UL sub-frames SF #6 and SF #7 defined in the present invention.

If the frame structure of FIG. 9 is used, the UL sub-map of the sub-frames SF #2 and SF #3 may include the scheduling information corresponding to the sub-frames SF #6 and SF #7. In order to indicate whether or not the super map is present in the current frame, in the present invention, one of the reserved bits of the existing FCH may be used as the super map indicator. If the super map indicator included in the FCH is set to “1” it is indicated that the super map is present in the current frame and, if the super map indicator is set to “0” it is indicated that the super map is not present in the current frame.

If the super map is present in the current super frame, the super map information may be transmitted to the MS in the form of the DL map information (using an extended DIUC code) as shown in Tables 10 and 11. The MS may read the DL map information DL-MAP IE and acquire the super map information.

Table 10 shows an example of the extended DIUC code used when the IEEE 802.16e BS for supporting the legacy system used in the present invention transmits the super map information to the MS in the form of the DL map information.

TABLE 10

| Extended DIUC | |
|---|---|
| (hexadecimal) | Usage |
| 00 | Channel_Measurement_IE |
| 01 | STC_Zone_IE |
| 02 | AAS_DL_IE |
| 03 | Data_location_in_another_BS_IE |
| 04 | CID_Switch_IE |
| 05 | SuperMAP_IE |
| 06 | Reserved |
| 07 | HARQ_Map_Pointer_IE |
| 08 | PHYMOD_DL_IE |
| 09-0A | Reserved |
| 0B | DL PUSC Burst Allocation in Other Segment |
| 0C | PUSC ASCA ALLOC IE |
| 0D-0E | Reserved |
| 0F | UL_interference_and_noise_level_IE |

Table 10 shows an example in which the extended DIUC value “05” is defined for a super map information element SuperMAP_IE. For the super map information element SuperMAP_IE for transmitting the super map information, in Table 10, the super map IE may be defined in the extended DIUC (e.g., 06, 09 to 0A and 0D to 0E) which is represented by “reserved”. In addition, although the method of specifying the extended DIUC in order to define the super map information element is described in Table 10, this may be allocated within the extended DIUC 2.

Table 11 shows an example of a super map information element format defined by the extended DIUC value “05”.

TABLE 11

| Syntax | Size | Contents |
|---|---|---|
| Super MAP_IE ( ) { | | |
| Extended DIUC | 4 bits | Super MAP IE = 0x05 |
| Length | 8 bits | |
| Basic System Information | TBD | System frame number - BS Reference Signal |
| | | Power - BS Status Information - Frame Configuration:DL/U: |
| | | ratio, TTG, RTG, N_OFDMA |
| | | symbols, etc. - Etc. |
| Sub-DCD/UCD | TBD | Sub-DCD/UCD group number - Change Count - |
| Scheduling Information | | Etc. |
| Sub-frame Configuration | TBD | Resource Allocation Type - Permutation Information, |
| | | Zone IE, etc. - Multi-carrier/Scalable |
| | | Bandwidth info - Sub-map Info * sub-map |
| | | decoding information - UL Control Channel Configuration |
| | | Information* ACK/NACK channel information |
| | | * high-speed feedback channel * ranging |
| | | channel information - sounding channel information - |
| | | Etc. |
| } | | |

Table 11 shows the super map including system information and frame configuration information in the form of the DL map information DL-MAP IE. That is, referring to Table 11, the super map IE may include an extended DIUC parameter indicating the DIUC code of the super map IE, a length field indicating the length of the super map information element, a basic system information field, a sub DCD/UCD scheduling information field, and a sub-frame configuration information field.

At this time, the basic system information field may include system frame number information, BS reference signal power information, BS status information, frame configuration information, etc. The sub-frame configuration information field may include a sub-frame resource allocation type, multi-carrier/scalable bandwidth information, sub-map information including sub-map decoding information, and UL control channel configuration information.

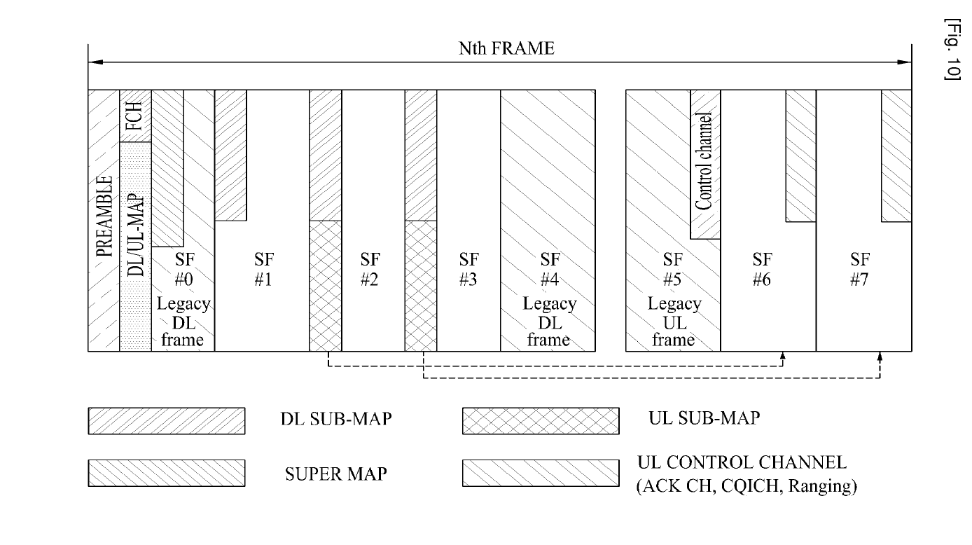

FIG. 10 is a view showing another example of a method of supporting the existing system using the sub-frame structure defined in the embodiment of the present invention.

The sub-frame structure of FIG. 10 is basically equal to that of FIG. 9. FIG. 10 is different from FIG. 9 in the configuration of the legacy frame for supporting the legacy system.

Referring to FIG. 10, a DL sub-frame (Legacy DL SF) allocated for the legacy system is located at sub-frames SF #0 and SF #4. In addition, a UL sub-frame (Legacy UL SF) for supporting the legacy system may be located at a sub-frame SF #5.

If the frame structure of FIG. 10 is used, a transmitter transmits DL bursts to a receiver at sub-frames SF #1, SF #2 and SF #3. The receiver may transmit a control signal (e.g., an ACK/NACK signal) for the DL bursts to the transmitter via a control channel (e.g., an ACK channel) of sub-frames SF #6 and SF #7 of the same frame.

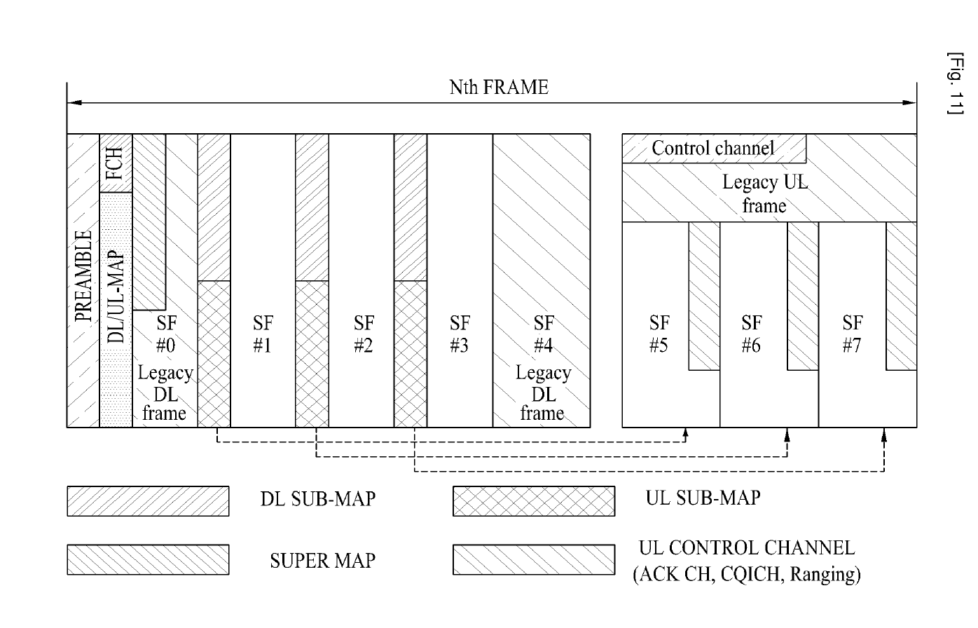

FIG. 11 is a view showing another example of a method of supporting the existing system using the sub-frame structure defined in the embodiment of the present invention.

The basic sub-frame structure of FIG. 11 is equal to that of FIG. 10. FIG. 11 shows another format of a legacy frame in order to support the legacy system. That is, FIG. 11 is different from FIG. 10 in the frame structure for supporting the legacy system included in the UL sub-frame.

Referring to FIG. 11, a UL frame (Legacy UL frame) for supporting the legacy system may be located at the sub-channels of UL sub-frames in the form of an FDM. That is, FIG. 11 shows the structure in which the UL frame is located at upper-level sub-channels of the UP sub-frames.

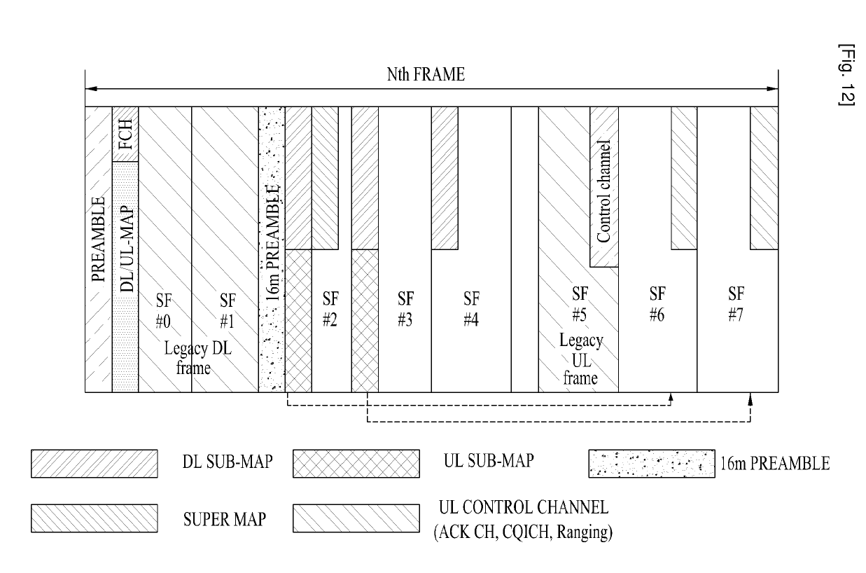

FIG. 12 is a view showing another example of a method of supporting the existing system using the sub-frame structure defined in the embodiment of the present invention.

The basic sub-frame structure of FIG. 12 is equal to that of FIG. 9. FIG. 12 shows the case where a preamble which is newly defined in the present invention is used when the legacy system is supported. That is, a 16 m preamble may be used.

The 16 m preamble may appear in every super frame (e.g., in a period of 20 ms), and the super map may be located at the sub-frame in which the 16 m preamble appears. At this time, the sub-map may include super map allocation information. In this case, a 16 m-mode mobile station may read only the 16 m preamble and use the sub-frame structure suggested in the present invention, without reading information about the legacy system. Accordingly, a data signal transmitted by every frame does not need to be read and efficient data processing is possible.

If the sub-frame structures of FIGS. 9 to 12 are used, it is possible to reduce the HARQ ACK delay and the HARQ retransmission delay. In addition, since the legacy system can be supported, the existing system can be continuously used although a new system is applied. In addition, it is possible to reduce DL control overhead by using the sub-map structures suggested in the embodiments of the present invention.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents. In addition, embodiments may be configured by combining claims which do not have an explicit citation relationship therebetween or new claims may be added by an amendment after the application.

### INDUSTRIAL APPLICABILITY

The embodiments of the present invention are applicable to various radio access systems. Examples of various radio access systems include the 3^{rd} generation partnership project (3GPP), the 3GPP2 and/or the institute of electrical and electronic engineers 802 (IEEE 802.xx). The embodiments of the present invention are applicable to all technical fields using the various radio access systems as well as the various radio access systems.

1. A communication method using a sub-map in a radio access system, the method comprising:
transmitting an uplink sub-map to a receiver at a first downlink sub-frame included in a predetermined frame; and
receiving a control signal via a data burst indicated by the uplink sub-map at a first uplink sub-frame included in the predetermined frame.

2. The method according to claim 1, wherein the uplink sub-map includes one or more sub-map headers and one or more sub-map bodies.

3. The method according to claim 2, wherein the one or more sub-map bodies use the same modulation coding scheme (MCS).

4. The method according to claim 2, wherein the one or more sub-map bodies use different modulation coding schemes (MCSs).

5. The method according to claim 2, wherein a first sub-map body of the one or more sub-map bodies includes uplink burst allocation information included in the first sub-frame.

6. The method according to claim 2, wherein a first sub-map header of the one or more sub-map headers includes a sub-map indicator indicating whether or not a second sub-map header is present next to the first sub-map header.

7. The method according to claim 6, wherein the first sub-map header and the second sub-map header use different modulation coding schemes (MCSs).

8. The method according to claim 6, wherein the first sub-map header and the second sub-map header are modulated and coded according to MCSs of uplink bursts corresponding thereto respectively.

9. The method according to claim 1, wherein the predetermined frame includes one or more downlink sub-frames and one or more uplink sub-frames.

10. A communication method using a sub-map in a radio access system, the method comprising:
transmitting a downlink sub-map to a receiver at a sub-frame included in a predetermined frame; and
transmitting a downlink signal via a downlink burst indicated by the downlink sub-map at the sub-frame.

11. The method according to claim 10, wherein the downlink sub-map includes one or more sub-map headers and one or more sub-map bodies.

12. The method according to claim 11, wherein the one or more sub-map bodies use the same modulation coding scheme (MCS).

13. A communication system using a sub-map in a radio access system, the method comprising:
receiving at least one of a downlink sub-map and an uplink sub-map of a first sub-frame included in a predetermined frame from a transmitter; and
receiving downlink data via a downlink burst indicated by a first downlink mini sub-map included in the downlink sub-map.

14. The method according to claim 13, further comprising transmitting uplink data via an uplink burst indicated by a first uplink mini sub-map included in the uplink sub-map,
wherein the uplink burst is a second sub-frame included in the predetermined frame.
